(19) United States
(12) Patent Application Publication
(10) Pub. No.: US 2025/0054441 A1
(43) Pub. Date: Feb. 13, 2025

(54) PIXEL DRIVING CIRCUIT, DISPLAY MODULE, DISPLAY APPARATUS AND INTELLIGENT WATCH

(71) Applicants: CHENGDU BOE OPTOELECTRONICS TECHNOLOGY CO., LTD., Sichuan (CN); BOE TECHNOLOGY GROUP CO., LTD., Beijing (CN)

(72) Inventors: Shengyi LI, Beijing (CN); Haitao CHENG, Beijing (CN); Qianqian LIU, Beijing (CN); Jing CHEN, Beijing (CN); Xin BI, Beijing (CN)

(73) Assignees: CHENGDU BOE OPTOELECTRONICS TECHNOLOGY CO., LTD., Sichuan (CN); BOE TECHNOLOGY GROUP CO., LTD., Beijing (CN)

(21) Appl. No.: 18/577,601

(22) PCT Filed: Apr. 18, 2023
(86) PCT No.: PCT/CN2023/089030

§ 371 Date: Aug. 2, 2024

(30) Foreign Application Priority Data
Apr. 22, 2022 (CN) 202210427079.0

(51) Int. Cl. G09G 3/3233

(52) U.S. Cl. CPC G09G 3/3233; G09G 2300/0819; G09G 2300/0842; G09G 2310/0254; G09G 2310/08; G09G 2320/0626; G09G 2360/144

(57) ABSTRACT

A pixel driving circuit (100) includes a photosensitive device (110) and a dimming sub-circuit (120) connected between a first voltage terminal (VDD) and a light-emitting device (200). A first terminal of the photosensitive device (110) is configured to receive a control signal, a second terminal of the photosensitive device (110) is electrically connected to a first node (N1), and the photosensitive device (110) is configured to adjust a voltage at the first node (N1) based on the control signal. The dimming sub-circuit (120) is electrically connected to the first node (N1). The on-state of the dimming sub-circuit (120) changes with a change of the voltage at the first node (N1), and the dimming sub-circuit (120) is configured to adjust brightness of the light-emitting device (200) based on a first voltage signal from the first voltage terminal (VDD) under control of the voltage at the first node (N1).

### CROSS-REFERENCE TO RELATED APPLICATIONS

This application is a national phase entry under 35 USC 371 of International Patent Application No. PCT/CN2023/089030, filed on Apr. 18, 2023, which claims priority to Chinese Patent Application No. 202210427079.0, filed on Apr. 22, 2022, which are incorporated herein by reference in their entirety.

### TECHNICAL FIELD

The present disclosure relates to the field of display technologies, and in particular, to a pixel driving circuit, a display module, a display apparatus and an intelligent watch.

### BACKGROUND

At present, most display apparatuses can achieve automatic adjustment of display brightness according to the ambient brightness. The ambient light sensor (ALS) realizes the automatic adjustment function of the brightness. Generally, the display apparatus includes a display panel and at least one flexible printed circuit on which the ALS and a plurality of peripheral devices are provided, and the flexible printed circuit is configured to electrically connect the ALS to the display panel.

### SUMMARY

In an aspect, a pixel driving circuit is provided. The pixel driving circuit includes a photosensitive device and a dimming sub-circuit. A first terminal of the photosensitive device being configured to receive a control signal, and a second terminal of the photosensitive device being electrically connected to a first node. A resistance of the photosensitive device changes as an intensity of light incident on the photosensitive device changes. The photosensitive device is configured to adjust a voltage at the first node based on the control signal. The dimming sub-circuit is connected between a first voltage terminal and a light-emitting device and is electrically connected to the first node. An on-state of the dimming sub-circuit changes as the voltage at the first node changes, and the dimming sub-circuit is configured to adjust brightness of the light-emitting device based on a first voltage signal from the first voltage terminal under control of the voltage at the first node.

In some embodiments, the pixel driving circuit further includes a driving transistor. A control electrode of the driving transistor is electrically connected to a second node, a first electrode of the driving transistor is electrically connected to a third node, and a second electrode of the driving transistor is electrically connected to a fourth node. The dimming sub-circuit includes a first transistor connected between the fourth node and the light-emitting device, and a control electrode of the first transistor is electrically connected to the first node.

In some embodiments, the first terminal of the photosensitive device is electrically connected to an enable signal terminal. The dimming sub-circuit further includes a second transistor. A control electrode of the second transistor is electrically connected to the first node or the enable signal terminal, a first electrode of the second transistor is electrically connected to the first voltage terminal, and a second electrode of the second transistor is electrically connected to the third node.

In some embodiments, the first terminal of the photosensitive device is electrically connected to a scan signal terminal. The dimming sub-circuit further includes a second transistor. A control electrode of the second transistor is electrically connected to the enable signal terminal, a first electrode of the second transistor is electrically connected to the first voltage terminal, and a second electrode of the second transistor is electrically connected to the third node.

In some embodiments, the first terminal of the photosensitive device is electrically connected to any one of an enable signal terminal, a scan signal terminal, a reset signal terminal, an initialization signal terminal, the first voltage terminal, a second voltage terminal, the second node, the third node or the fourth node. The light-emitting device is electrically connected to the second voltage terminal.

The dimming sub-circuit further includes a second transistor and a third transistor. A control electrode of the second transistor is electrically connected to the enable signal terminal, a first electrode of the second transistor is electrically connected to the first voltage terminal, and a second electrode of the second transistor is electrically connected to the third node. A control electrode of the third transistor is electrically connected to the enable signal terminal, the third transistor is connected between the fourth node and the light-emitting device, and the third transistor and the first transistor are connected in series.

In some embodiments, the pixel driving circuit further includes a capacitor, a fourth transistor, a fifth transistor, a sixth transistor and a seventh transistor. A first electrode plate of the capacitor is electrically connected to the first voltage terminal, and a second electrode plate of the capacitor is electrically connected to the second node. A control electrode of the fourth transistor is electrically connected to a scan signal terminal, a first electrode of the fourth transistor is electrically connected to a data signal terminal, and a second electrode of the fourth transistor is electrically connected to the third node. A control electrode of the fifth transistor is electrically connected to the scan signal terminal, a first electrode of the fifth transistor is electrically connected to the fourth node, and a second electrode of the fifth transistor is electrically connected to the second node. A control electrode of the sixth transistor is electrically connected to a reset signal terminal, a first electrode of the sixth transistor is electrically connected to an initialization signal terminal, and a second electrode of the sixth transistor is electrically connected to the second node. A control electrode of the seventh transistor is electrically connected to the scan signal terminal, a first electrode of the seventh transistor is electrically connected to the initialization signal terminal, and a second electrode of the seventh transistor is electrically connected to the light-emitting device.

In some embodiments, the dimming sub-circuit further includes a second transistor. A control electrode of the second transistor is electrically connected to the first node or an enable signal terminal, a first electrode of the second transistor is electrically connected to the first voltage terminal, and a second electrode of the second transistor is electrically connected to the third node. Alternatively, the dimming sub-circuit further includes a second transistor and a third transistor. A control electrode of the second transistor is electrically connected to the enable signal terminal, a first electrode of the second transistor is electrically connected to the first voltage terminal, and a second electrode of the second transistor is electrically connected to the third node. A control electrode of the third transistor is electrically connected to the enable signal terminal, the third transistor is connected between the fourth node and the light-emitting device, and the third transistor and the first transistor are connected in series. In a case where the first terminal of the photosensitive device is electrically connected to any one of the first voltage terminal, the scan signal terminal, the third node and the fourth node, a polarity of the first transistor is opposite to polarities of the driving transistor, the second transistor, and the fourth to seventh transistors; and in a case where the dimming sub-circuit further includes the third transistor, the polarity of the first transistor is also opposite to a polarity of the third transistor. In a case where the first terminal of the photosensitive device is electrically connected to any one of the enable signal terminal, the reset signal terminal, the initialization signal terminal, a second voltage terminal and the second node, the polarity of the first transistor is same as the polarities of the driving transistor, the second transistor, and the fourth to seventh transistors; and in the case where the dimming sub-circuit further includes the third transistor, the polarity of the first transistor is also same as the polarity of the third transistor.

In some other embodiments, the pixel driving circuit further includes a driving transistor. A control electrode of the driving transistor is electrically connected to a second node, a first electrode of the driving transistor is electrically connected to a third node, and a second electrode of the driving transistor is electrically connected to a fourth node. The dimming sub-circuit includes a first transistor. A control electrode of the first transistor is electrically connected to the first node, a first electrode of the first transistor is electrically connected to the first voltage terminal, and a second electrode of the first transistor is electrically connected to the third node.

In some embodiments, the first terminal of the photosensitive device is electrically connected to an enable signal terminal or a scan signal terminal. The dimming sub-circuit further includes a second transistor. A control electrode of the second transistor is electrically connected to the enable signal terminal, a first electrode of the second transistor is electrically connected to the fourth node, and a second electrode of the second transistor is electrically connected to the light-emitting device.

In some embodiments, the pixel driving circuit further includes a capacitor, a fourth transistor, a fifth transistor, a sixth transistor and a seventh transistor. A first electrode plate of the capacitor is electrically connected to the first voltage terminal, and a second electrode plate of the capacitor is electrically connected to the second node. A control electrode of the fourth transistor is electrically connected to a scan signal terminal, a first electrode of the fourth transistor is electrically connected to a data signal terminal, and a second electrode of the fourth transistor is electrically connected to the third node. A control electrode of the fifth transistor is electrically connected to the scan signal terminal, a first electrode of the fifth transistor is electrically connected to the fourth node, and a second electrode of the fifth transistor is electrically connected to the second node. A control electrode of the sixth transistor is electrically connected to a reset signal terminal, a first electrode of the sixth transistor is electrically connected to an initialization signal terminal, and a second electrode of the sixth transistor is electrically connected to the second node. A control electrode of the seventh transistor is electrically connected to the scan signal terminal, a first electrode of the seventh transistor is electrically connected to the initialization signal terminal, and a second electrode of the seventh transistor is electrically connected to the light-emitting device.

In some embodiments, the dimming sub-circuit further includes a second transistor. A control electrode of the second transistor is electrically connected to an enable signal terminal, a first electrode of the second transistor is electrically connected to the fourth node, and a second electrode of the second transistor is electrically connected to the light-emitting device. In a case where the first terminal of the photosensitive device is electrically connected to any one of the first voltage terminal, the scan signal terminal, the third node and the fourth node, a polarity of the first transistor is opposite to polarities of the driving transistor, the second transistor, and the fourth to seventh transistors. In a case where the first terminal of the photosensitive device is electrically connected to any one of the enable signal terminal, the reset signal terminal, the initialization signal terminal, a second voltage terminal and the second node, the polarity of the first transistor is same as the polarities of the driving transistor, the second transistor, and the fourth to seventh transistors.

In another aspect, a display module is provided. The display module includes a substrate, a plurality of pixel driving circuits each as described in any of the above embodiments, and a plurality of light-emitting devices. The plurality of pixel driving circuits are disposed on the substrate. The plurality of light-emitting devices are disposed on a side of the plurality of pixel driving circuits away from the substrate, and the light-emitting devices are electrically connected to the pixel driving circuits.

In some embodiments, the display module has a light-transmitting area, the light-transmitting area is provided with at least one photosensitive device therein, and each photosensitive device is electrically connected to multiple pixel driving circuits in the plurality of pixel driving circuits.

In some embodiments, the display module further includes a photosensitive layer, and the photosensitive layer is disposed on the side of the plurality of pixel driving circuits away from the substrate. The photosensitive layer includes a plurality of photosensitive devices, and each photosensitive device is electrically connected to one or more pixel driving circuits in the plurality of pixel driving circuits.

In some embodiments, the display module further includes a chip on film and a flexible printed circuit. The chip on film is electrically connected to the plurality of pixel driving circuits. The flexible printed circuit is electrically connected to the chip on film. A surface of the flexible printed circuit is provided with at least one photosensitive device thereon, and in a case of the flexible printed circuit being bent to a back side of the substrate, the photosensitive device is closer to the substrate than the flexible printed circuit. Each photosensitive device is electrically connected to multiple pixel driving circuits in the plurality of pixel driving circuits.

In yet another aspect, a display apparatus is provided. The display apparatus includes the display module as described in any of the above embodiments and a housing.

In yet another aspect, an intelligent watch is provided. The intelligent watch includes the display module as described in any of the above embodiments and a supporting component.

### BRIEF DESCRIPTION OF THE DRAWINGS

In order to describe technical solutions in the embodiments of the present disclosure or in the prior art more clearly, accompanying drawings to be used in the embodiments or the prior art will be introduced briefly below. Obviously, the accompanying drawings to be described below are merely accompanying drawings of some embodiments of the present disclosure, and a person of ordinary skill in the art may obtain other drawings according to these drawings without paying any creative effort. In addition, the accompanying drawings to be described below may be regarded as schematic diagrams, but are not limitations on an actual size of a product to which the embodiments of the present disclosure relate.

FIG. 1A is a structural diagram of a display module in the prior art;

FIG. 1B is a structural diagram of another display module in the prior art;

FIG. 1C is a partial cross-sectional view of a chip on film of the display module provided in FIG. 1B after being bent;

FIG. 2 is a structural diagram of a display apparatus, in accordance with some embodiments;

FIG. 3A is a structural diagram of a display module in the display apparatus provided in FIG. 2;

FIG. 3B is a structural diagram of another display module in the display apparatus provided in FIG. 2;

FIG. 4 is a diagram showing a pixel arrangement in a display apparatus, in accordance with some embodiments;

FIG. 5 is a diagram showing a pixel architecture in a display apparatus, in accordance with some embodiments;

FIG. 6A is a cross-sectional view of a display panel in the display apparatus provided in FIG. 4 taken along a section line CC;

FIG. 6B is a cross-sectional view of another display panel in the display apparatus provided in FIG. 4 taken along a section line CC;

FIG. 7 is a schematic diagram of a pixel driving circuit, in accordance with some embodiments;

FIG. 8A is a schematic diagram of another pixel driving circuit, in accordance with some embodiments;

FIG. 8B is a schematic diagram of yet another pixel driving circuit, in accordance with some embodiments;

FIG. 9A is a schematic diagram of yet another pixel driving circuit, in accordance with some embodiments;

FIG. 9B is a schematic diagram of yet another pixel driving circuit, in accordance with some embodiments;

FIG. 10 is a schematic diagram of yet another pixel driving circuit, in accordance with some embodiments;

FIG. 11 is a schematic diagram of yet another pixel driving circuit, in accordance with some embodiments;

FIG. 12 is a schematic diagram of yet another pixel driving circuit, in accordance with some embodiments;

FIG. 13 is a schematic diagram of yet another pixel driving circuit, in accordance with some embodiments;

FIG. 14 is a schematic diagram of yet another pixel driving circuit, in accordance with some embodiments;

FIG. 15 is a schematic diagram of yet another pixel driving circuit, in accordance with some embodiments;

FIG. 16 is a schematic diagram of yet another pixel driving circuit, in accordance with some embodiments;

FIG. 17 is a schematic diagram of yet another pixel driving circuit, in accordance with some embodiments;

FIG. 18 is a schematic diagram of yet another pixel driving circuit, in accordance with some embodiments;

FIG. 19 is a schematic diagram of yet another pixel driving circuit, in accordance with some embodiments;

FIG. 20 is a schematic diagram of yet another pixel driving circuit, in accordance with some embodiments;

FIG. 21 is a schematic diagram of yet another pixel driving circuit, in accordance with some embodiments; and

FIG. 22 is a timing diagram of a pixel driving circuit, in accordance with some embodiments.

### DETAILED DESCRIPTION

Technical solutions in some embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics described herein may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Thus, features defined with “first” or “second” may explicitly or implicitly include one or more of the features. In the description of the embodiments of the present disclosure, the term “a plurality of” or “the plurality of” means two or more unless otherwise specified.

In the description of some embodiments, the expressions “connected” and derivatives thereof may be used. For example, the term “connected” may be used in the description of some embodiments to indicate that two or more components are in direct physical or electrical contact with each other. The embodiments disclosed herein are not necessarily limited to the content herein.

The phrase “A and/or B” includes the following three combinations: only A, only B, and a combination of A and B.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “applicable to” or “configured to” as used herein indicates an open and inclusive expression, which does not exclude apparatuses that are applicable to or configured to perform additional tasks or steps.

Exemplary embodiments are described herein with reference to sectional views and/or plan views as idealized exemplary drawings. In the accompanying drawings, thicknesses of layers and sizes of regions are enlarged for clarity. Variations in shapes relative to the accompanying drawings due to, for example, manufacturing technologies and/or tolerances may be envisaged. Therefore, the exemplary embodiments should not be construed to be limited to the shapes of regions shown herein, but to include deviations in the shapes due to, for example, manufacturing. For example, an etched region shown in a rectangular shape generally has a feature of being curved. Therefore, the regions shown in the accompanying drawings are schematic in nature, and their shapes are not intended to show actual shapes of the regions in an apparatus, and are not intended to limit the scope of the exemplary embodiments.

Currently, the ambient light sensor (ALS) is used to sense light intensity, and the display brightness of the display apparatus is adjusted according to the sensed light intensity. For example, if the light intensity sensed by the ALS is strong, a signal for adjusting the display brightness to increase is output, so that the user may clearly see the display image of the display apparatus. If the light intensity sensed by the ALS is weak, a signal for adjusting the display brightness to decrease is output, so as to reduce an adverse stimulation to the human eye caused by excessive display brightness in a case where the user can clearly see the display image of the display apparatus. Moreover, reducing the display brightness may reduce energy consumption of a battery.

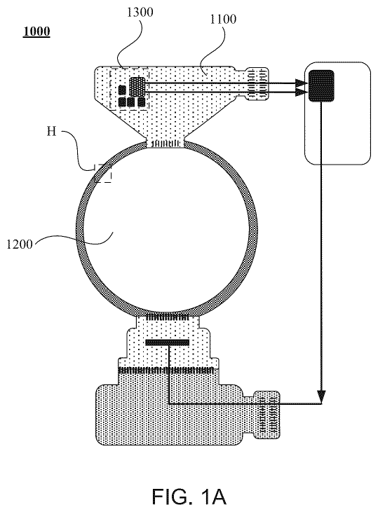

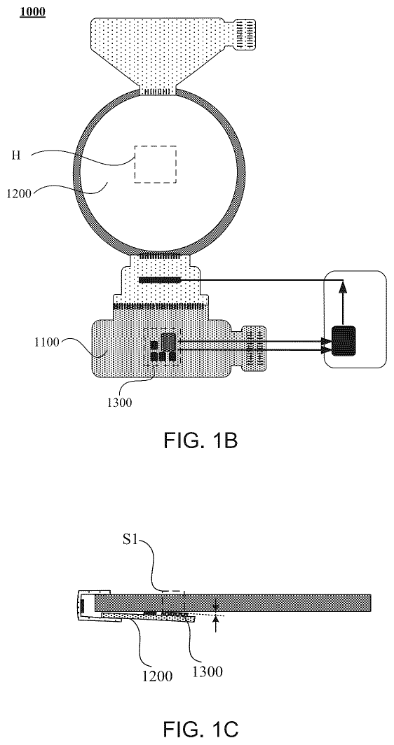

However, during adjusting the display brightness by using the ALS, the ALS performs information process according to the sensed light intensity, and performs information interaction with a processor in the display apparatus, so that the processor controls the display brightness of the display apparatus. In this way, operation of the ALS and the processor generates great power consumption. The display apparatus such as an intelligent watch is usually powered by a battery (batteries). Due to the limited energy storage capacity of the battery, the use of the ALS is obviously not conducive to the endurance of the display apparatus. For example, as shown in FIGS. 1A to 1C, the display apparatus 1000 includes at least two flexible printed circuits 1100 and a display panel 1200. In a case where the ALS 1300 is provided on the flexible printed circuit 1100 and the flexible printed circuit 1100 is bent to a non-display surface of the display panel 1200, as shown in FIG. 1C, the flexible printed circuit 1100 has a certain hardness and is prone to warping, which causes the ALS 1300 unable to be in close contact with the display panel 1200 due to a gap between the ALS 1300 and the display panel 1200. Further, a light-transmitting area H of the display panel 1200 exposing the ALS 1300 is misaligned with the ALS 1300. The light-transmitting area H cannot completely expose the ALS 1300, resulting in affecting a light sensitivity effect of the ALS 1300. It can be understood that if the light-transmitting area H is located in a peripheral area, an opening is provided in a housing that overlaps with an orthographic projection of the light-transmitting area H; and if the light-transmitting area H is located in a display area, each film layer located in the light-transmitting area H and on a side of the ALS 1300 facing the display surface is a transparent film layer, so as to allow external ambient light to be incident on the ALS 1300. In addition, there are many peripheral devices (e.g., two filter capacitors and adjustable resistors) that work together with the ALS 1300 and occupy a relatively large space, which is not conducive to lightness and thinness of the display apparatus 1000.

In order to solve the above problems, some embodiments of the present disclosure provide a display apparatus. The display apparatus can perform automatic dimming according to current ambient light intensity without adding an ALS, a step of ALS attachment process may be reduced, and the process efficiency and yield may be improved.

The display apparatus may be any apparatus having a display function, such as a tablet computer, a monitor, a mobile phone, a billboard, a digital photos frame or a personal digital assistant (PDA). For example, as shown in FIG. 2, the display apparatus 2000 provided by some embodiments of the present disclosure is an intelligent watch 2001.

Embodiments of the present disclosure do not limit a specific type of the display apparatus 2000. For example, the display apparatus 2000 may be an organic light-emitting diode (OLED) display apparatus such as an active matrix organic light-emitting diode (AMOLED) display apparatus, or a quantum dot light-emitting diode (QLED) display apparatus. The following embodiments will be described in detail by taking the OLED display apparatus as an example.

In some embodiments, as shown in FIG. 2, the display apparatus 2000 includes a display module 2200 and a housing 2100. The housing 2100 includes a frame 2101, a back cover (not shown in the figure) and other components, and is configured to provide protection and support for the display module 2200. For example, as shown in FIG. 2, the display apparatus 2000 is an intelligent watch 2001. The intelligent watch 2001 includes the display module 2200, the housing 2100 and a supporting component 2300. The supporting component 2300 is configured to be connected to the housing 2100 to facilitate wearing the display apparatus 2000. For example, the supporting component 2300 includes a watch band 2301.

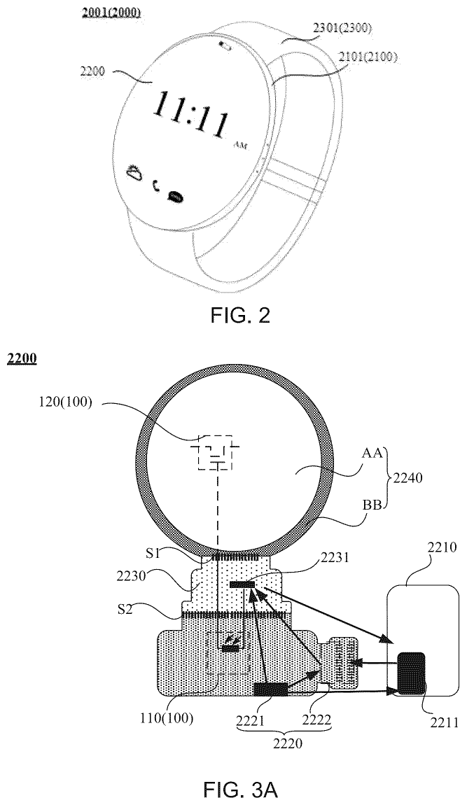

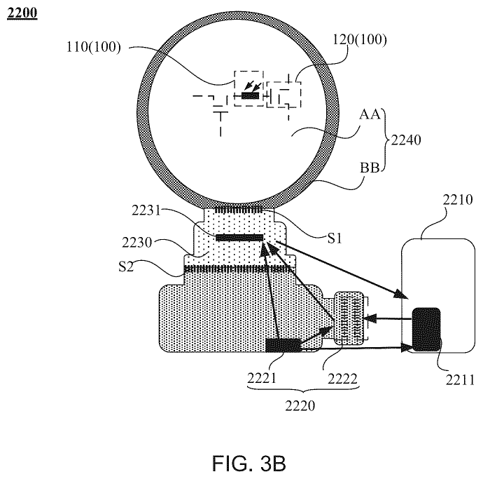

In some examples, as shown in FIGS. 3A and 3B, the display module 2200 includes a mainboard 2210, a flexible printed circuit 2220, a chip on film 2230, and a display panel 2240.

The mainboard 2210 is provided with a central processing unit (CPU) 2211 thereon. The mainboard 2210 is electrically connected to the flexible printed circuit 2220, and is configured to control a timing controller (TCON) 2222 to output a timing control signal.

The flexible printed circuit 2220 and the chip on film 2230 are electrically connected by second pins S2. The flexible printed circuit 2220 is provided with drive circuits such as a power manager 2221 and the TCON 2222. The power manager 2221 is configured to transmit a processed power supply voltage signal to the TCON 2222, the chip on film 2230, and the processing unit 2211, so as to power up the TCON 2222, the chip on film 2230, and the processing unit 2211.

The chip on film 2230 (COF) is electrically connected to the display panel 2240 by first pins S1, and the chip on film 2230 is provided with a driver chip 2231 thereon. For example, the driver chip 2231 is a source driver chip (a source driver IC). The source driver chip is electrically connected to a plurality of pixel driving circuits 100 in the display panel 2240 and is configured to transmit a data signal to pixel driving circuits 100. The TCON 2222 is electrically connected to the source driver chip and is configured to transmit the timing control signal to the source driver chip, so as to control the source driver chip to output a required data signal.

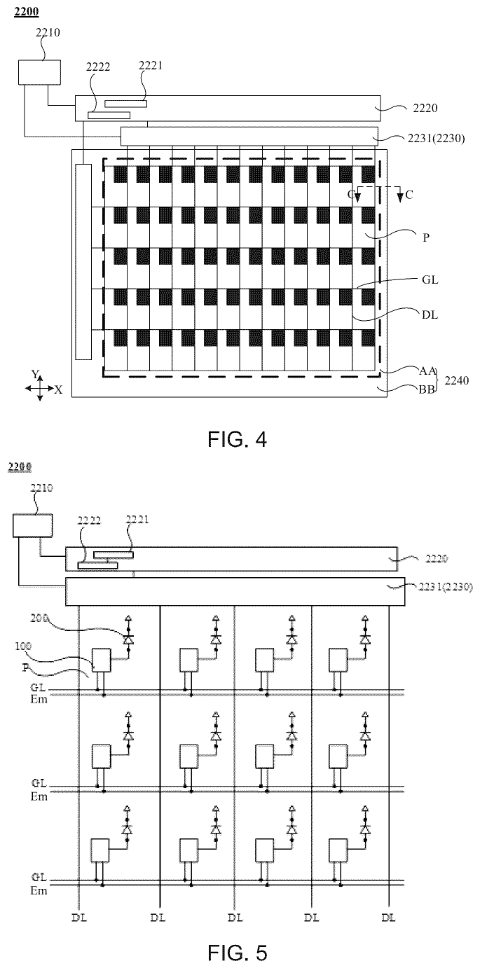

As shown in FIGS. 3A, 3B and 4, the display panel 2240 includes a display area (also referred to as an active area) AA and a peripheral area BB located on at least one side of the display area AA. FIG. 4 illustrates an example in which the peripheral area BB is disposed around the display area AA, and shapes of the peripheral area BB and the display area AA are not limited. The display area AA includes a plurality of sub-pixel units P arranged in an array. For example, sub-pixel units P arranged in a line in a horizontal direction X are referred to as sub-pixel units in a same row, and sub-pixel units P arranged in a line in a vertical direction Y are referred to as sub-pixel units in a same column. For example, as shown in FIG. 5, the sub-pixel units P in the same row may be connected to at least one gate line GL and a light-emitting control signal line Em, and the sub-pixel units P in the same column may be connected to a data line DL.

With continued reference to FIG. 5, the sub-pixel unit P is provided therein with a pixel driving circuit 100 for controlling display of the sub-pixel unit P and a light-emitting device 200. The gate line GL connected to the sub-pixel units P is used to transmit a scan signal gate to pixel driving circuits 100 of the sub-pixel units P. The light-emitting control signal line Em connected to the sub-pixel units P is used to transmit an enable signal em to the pixel driving circuits 100 of the sub-pixel units P. A reset signal line connected to the sub-pixel units P is used to transmit a reset signal reset to the pixel driving circuits 100 of the sub-pixel units P (the reset signal line is another gate line, that is, a scan signal gate transmitted by an Nth gate line GL is used as a reset signal reset of an (N+1)th row). The data line DL connected to the sub-pixel units P is used to transmit a data signal vdata to the pixel driving circuits 100 of the sub-pixel units P, and the data signal vdata is from the source driver chip electrically connected to all the data lines DL.

It will be noted that in subsequent embodiments, a signal line electrically connected to a scan signal terminal Gate is the gate line GL, a signal line electrically connected to a reset signal terminal Reset is the reset signal line, and a signal line electrically connected to an enable signal terminal EM is the light-emitting control signal line Em.

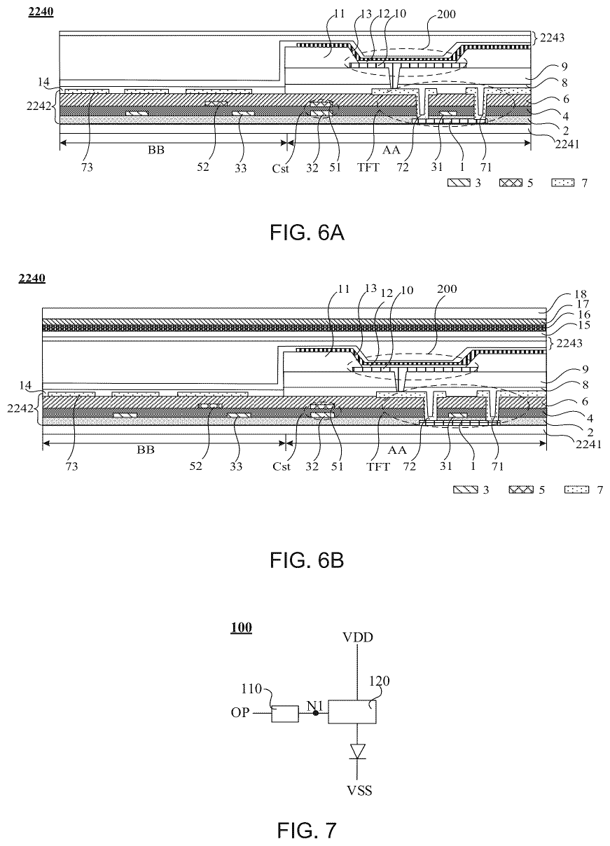

The pixel driving circuit 100 and the light-emitting device 200 are exemplarily illustrated below according to a specific film layer structure of the display panel 2240. As shown in FIGS. 6A and 6B, the display panel 2240 includes a substrate 2241, a driving circuit stacked layer 2242, a plurality of light-emitting devices 200 and an encapsulation layer 2243 that are arranged in stack.

The substrate 2241 may be flexible and includes one or more materials of polyethersulfone (PES), polyarylate (PAR), polyetherimide (PEI), polyethylene naphthalate (PEN), polyethylene terephthalate (PET), polyphenylene sulfide (PPS), polyimide (PI), polycarbonate (PC), cellulose triacetate (TAC) and cellulose acetate propionate (CAP). For example, the material of the substrate 2241 includes polyimide.

In some examples, as shown in FIGS. 6A and 6B, the driving circuit stacked layer 2242 refers to film layers in which the plurality of pixel driving circuits 100 arranged in an array are located, and includes a plurality of patterned conductive layers and insulating layers. The pixel driving circuits 100 are disposed on the substrate 2241. Each pixel driving circuit 100 includes a plurality of thin film transistors (TFTs) and at least one capacitor Cst. In a direction perpendicular to the driving circuit stacked layer 2242, the driving circuit stacked layer 2242 includes a semiconductor layer 1, a gate insulating layer 2, a first gate metal layer 3, a first insulating layer 4, a second gate metal layer 5, a second insulating layer 6, a conductive layer 7, a third insulating layer 8, and a planarization layer 9.

The first gate metal layer 3 includes gates 31 of the plurality of TFTs, first electrode plates 32 of a plurality of capacitors Cst, and a plurality of first gate scan lines 33 (i.e., the gate lines GL). The second gate metal layer 5 includes second electrode plates 51 of the plurality of capacitors Cst and a plurality of second gate scan lines 52. The conductive layer 7 includes sources 71 and drains 72 of the plurality of TFTs, and a plurality of signal lines 73 (e.g., including data lines DL, first voltage signal lines and second voltage signal lines).

The plurality of light-emitting devices 200 are disposed on a side of the plurality of pixel driving circuits 100 away from the substrate 2241, and the light-emitting devices 200 are electrically connected to the pixel driving circuit 100. Film layers in which the plurality of light-emitting devices 200 are located include a plurality of pixel anodes 10, a pixel defining layer 11, a light-emitting function layer 12 and a cathode layer 13. Portions, whose orthographic projections on the substrate 2241 are overlapped, of a pixel anode 10 (for providing holes), the light-emitting function layer 12 and the cathode layer 13 may constitute a light-emitting device 200. The pixel anode 10 and the cathode layer 13 respectively inject holes and electrons into the light-emitting function layer 12, and excitons generated by a combination of the holes and the electrons produce light when transition from an excited state to a ground state.

The encapsulation layer 2243 is provided on a side of the cathode layer 13 away from the substrate 2241. The encapsulation layer 2243 may be encapsulation film(s). The number of layers of the encapsulation film(s) included in the encapsulation layer 2243 is not limited. In some embodiments, the encapsulation layer 2243 may include one layer of encapsulation film, or include two or more layers of encapsulation films that are stacked. For example, the encapsulation layer 2243 includes inorganic/organic/inorganic three-layer material films that are sequentially stacked, and the inorganic material may be one or more of silicon nitride (SiNx), silicon oxynitride (SiON) or silicon oxide (SiOx).

It will be noted that the transistors used in the pixel driving circuit 100 provided by the embodiments of the present disclosure may be thin film transistors (TFTs), field effect transistors (e.g., metal oxide semiconductor transistors, MOS transistors) or other switching devices with same characteristics, and the embodiments of the present disclosure are described by taking the thin film transistors as an example.

A control electrode of each thin film transistor used in the pixel driving circuit 100 is a gate of the transistor, a first electrode thereof is one of a source and a drain of the thin film transistor, and a second electrode thereof is the other of the source and the drain of the thin film transistor. Since the source and the drain of the thin film transistor may be symmetrical in structure, there may be no difference in structure between the source and the drain of the transistor. That is, there may be no difference in structure between the first electrode and the second electrode of the thin film transistor in the embodiments of the present disclosure. For example, in a case where the thin film 20) transistor is a P-type transistor, a first electrode of the thin film transistor is a source, and a second electrode of the thin film transistor is a drain. For example, in a case where the thin film transistor is an N-type transistor, the first electrode of the transistor is the drain, and the second electrode of the transistor is the source.

As shown in FIGS. 3A and 3B, the chip on film 2230 and the display panel 2240 are electrically connected by a plurality of first pins S1. The chip on film 2230 is provided with the plurality of first pins S1 thereon, and the plurality of first pins are electrically connected to the driver chip 2231. The peripheral area BB of the display panel 2240 is provided with extension sections of the plurality of signal lines 73 (not shown in the figures). In this way, the plurality of signal lines 73 are electrically connected to the plurality of pixel driving circuits 100, and the extension sections of the plurality of signal lines 73 are electrically connected to the plurality of first pins S1, so as to realize the electrical connection between the driver chip 2231 of the chip on film 2230 and the plurality of pixel driving circuits 100. Moreover, as shown in FIGS. 6A and 6B, the encapsulation layer 2243 located in the peripheral area BB will expose the extension sections of the plurality of signal lines 73, that is, no encapsulation layer 2243 is provided on the extension sections of the plurality of signal lines 73, so as to facilitate the electrical connection between the extension sections of the plurality of signal lines 73 and the first pins S1 of the chip on film 2230 by attaching conductive adhesive 14 to the extension sections of the plurality of signal lines 73.

In some examples, as shown in FIGS. 3A and 3B, the display module 2200 further includes at least one photosensitive device 110, and at least one pixel driving circuit 100 in the display panel 2240 includes the photosensitive device 110.

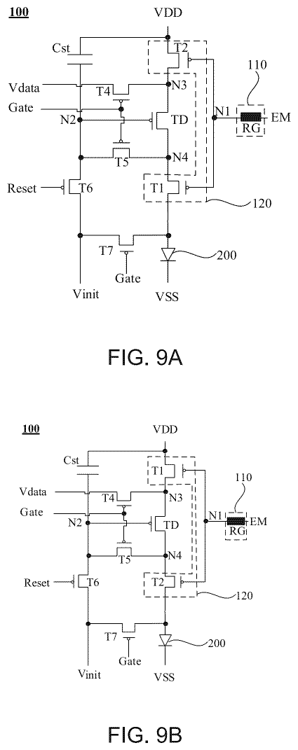

For example, as shown in FIG. 3A, in a case where at least one photosensitive device 110 is provided on a surface of the flexible printed circuit 2220, and the flexible printed circuit 2220 is bent to a back side of the substrate 2241, the photosensitive 20) device 110 is closer to the substrate 2241 than the flexible printed circuit 2220. In combination with FIG. 6A, the display panel 2240 is not provided with a film layer where the photosensitive device 110 is located. For example, a chip photoresistor RG (shown in FIGS. 9A to 21) is provided on the flexible printed circuit 2220, and at least one pixel driving circuit 100 in the display panel 2240 is electrically connected to the chip photoresistor RG.

As another example, as shown in FIG. 3B, the display panel 2240 is provided with at least one photosensitive device 110 therein. As shown in FIG. 6B, the film layer (i.e., the photosensitive layer 17) where the photosensitive device 110 is located is provided in the display panel 2240. The photosensitive layer 17 is disposed on a side of the plurality of pixel driving circuits 100 away from the substrate 2241. The photosensitive layer 17 includes the at least one photosensitive device 110 (not shown in the figure), and each photosensitive device 110 is electrically connected to multiple pixel driving circuits 100. Considering that the display panel 2240 may further include a touch layer 15 and a circular polarizer 16, in order to improve the light sensing sensitivity of the photosensitive device 110, the photosensitive layer 17 is disposed on a side of the circular polarizer 16 away from the substrate 2241. In this way, the external ambient light is incident on the photosensitive layer 17 through a glass cover 18, thereby reducing loss of light flux incident on the photosensitive device 110 and improving sensing efficiency and sensitivity of the photosensitive device 110.

In some examples, the display module 2200 has a light-transmitting area (not shown in the figure). The light-transmitting area is provided with at least one photosensitive device 110 therein. The light-transmitting area can transmit external ambient light to the photosensitive device(s) 110.

It can be understood that in a case where the pixel driving circuit 100 adjusts brightness of the light-emitting device 200 in response to the photosensitive device 110, the processing unit 2211 may obtain a voltage flowing through the photosensitive device 110 and perform information processing, so as to adjust the brightness of the light-emitting devices 200 in the entire display area AA. The present disclosure does not specifically limit an information interaction manner between the processing unit 2211 and the pixel driving circuit 100 having the photosensitive device 110.

For example, the light-transmitting area is an opening (not shown in the figure) in the frame 2101, and the opening exposes the photosensitive device 110, so that the photosensitive device 110 can sense light.

Alternatively, the light-transmitting area is located in the peripheral area BB of the display panel 2240. For example, the light-transmitting area is located proximate to a camera (not shown in the figure) of the display apparatus 2000, so as to avoid the influence of the photosensitive device 110 on an aperture ratio of the display area AA.

Alternatively, the light-transmitting area is located in the display area AA of the display panel 2240. For example, the light-transmitting area is the entire display area AA. In this way, the photosensitive layer 17 includes a plurality of photosensitive devices 110, and each pixel driving circuit 100 is provided to be electrically connected to a photosensitive device 110, so as to improve the photosensitive sensing efficiency.

On this basis, with reference to FIGS. 7 to 21, some embodiments of the present disclosure provide a pixel driving circuit 100.

As shown in FIG. 7, the pixel driving circuit 100 includes a photosensitive device 110 and a dimming sub-circuit 120. A first terminal of the photosensitive device 110 is configured to receive a control signal Ctl, and a second terminal of the photosensitive device 110 is electrically connected to a first node N1. The control signal Ctl is one of various signals output by a control terminal OP. For example, as shown in FIGS. 9A to 21, one of some original signals in the pixel driving circuit 100 may be further used as the control signal Ctl, such as the em signal, a vinit signal, a vdd signal, the gate signal and the reset signal. Alternatively, a voltage signal of one of some nodes in the pixel driving circuit 100 may be further used as the control signal Ctl, such as a voltage signal of a second node N2, a voltage signal of a third node N3 and a voltage signal of a fourth node N4. The control signal Ctl does not affect the driving process of the pixel driving circuit 100, and allows the light-emitting device 200 to emit light normally in a process of the pixel driving circuit 100 driving the light-emitting device 200 to emit light. The second node N2, the third node N3, and the fourth node N4 are equivalent circuit nodes in the pixel driving circuit 100.

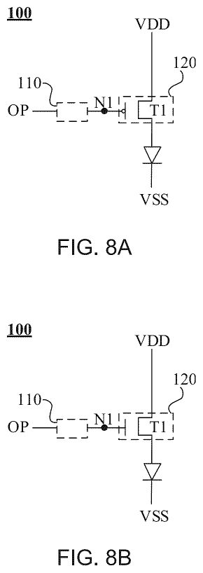

The resistance of the photosensitive device 110 changes as the intensity of the light incident on the photosensitive device 110 changes, and the photosensitive device 110 is configured to adjust the voltage at the first node N1 based on the control signal Ctl. For example, as shown in FIG. 8A, the resistance of the photosensitive device 110 increases as the intensity of light incident on the photosensitive device 110 increases, and the voltage and current flowing through the photosensitive device 110 decrease, that is, the voltage at the first node N1 decreases as the intensity of light incident on the photosensitive device 110 increases, so as to control an on-state of the dimming sub-circuit 120. Alternatively, as shown in FIG. 8B, the resistance of the photosensitive device 110 decreases as the intensity of the light incident on the photosensitive device 110 increases, and the voltage and current flowing through the photosensitive device 110 increase, that is, the voltage at the first node N1 increases as the intensity of the light incident on the photosensitive device 110 increases, so as to control the on-state of the dimming sub-circuit 120. The characteristics of the photosensitive device 110 are related to the material used for making the photosensitive device 110, and limiting voltages at the first node N1 (i.e., the voltage at the first node N1 transmitted from the control signal Ctl in a case of the maximum and minimum resistance of the photosensitive device 110) may control the dimming sub-circuit 120 to be turned on to transmit at least part of a first voltage signal vdd from a first voltage terminal VDD to the light-emitting device 200, so that the light-emitting device 200 emits light.

For example, the photosensitive device 110 includes one or more of a photoresistor RG, a photodiode and a phototransistor, which is selected according to the need of adjusting the voltage at the first node N1. As shown in FIGS. 9A to 21, the photosensitive device 110 is described by considering the photoresistor RG as an example.

The first node N1 is electrically connected to the dimming sub-circuit 120, and the dimming sub-circuit 120 is connected between the first voltage terminal VDD and the light-emitting device 200. In this way, under control of the voltage at the first node N1, the on-state of the dimming sub-circuit 120 changes with the change of the voltage at the first node N1, so as to adjust the brightness of the light-emitting device 200 based on the first voltage signal vdd from the first voltage terminal VDD under the control of the voltage at the first node N1.

For example, when the voltage at the first node N1 increases, the conduction degree of the dimming sub-circuit 120 increases, the voltage (and current) of the first voltage signal vdd transmitted to the light-emitting device 200 increases, and the brightness of the light-emitting device 200 increases.

As another example, when the voltage at the first node N1 decreases, the conduction degree of the dimming sub-circuit 120 decreases, the voltage (and current) of the first voltage signal vdd transmitted to the light-emitting device 200 decreases, and the brightness of the light-emitting device 200 decreases.

In this way, the pixel driving circuit 100 may achieve automatic adjustment of the brightness of the light-emitting device 200 through the photosensitive device 110 and the dimming sub-circuit 120 electrically connected to the photosensitive device 110 without the need for information interaction with additional dimming component(s), thereby reducing the complexity of the circuit structure.

The light-emitting device 200 may be a diode with self-luminous properties such as an OLED, a QLED or a LED, which may be selected by those skilled in the art according to actual needs.

As shown in FIGS. 9A to 21, the pixel driving circuit 100 further includes a driving transistor TD. A control electrode of the driving transistor TD is electrically connected to the second node N2, a first electrode of the driving transistor TD is electrically connected to the third node N3, and a second electrode of the driving transistor TD is electrically connected to the fourth node N4.

In some embodiments, as shown in FIGS. 9A, 10, 11 and 14 to 21, the dimming sub-circuit 120 includes a first transistor T1, the first transistor T1 is connected between the fourth node N4 and the light-emitting device 200, and a control electrode of the first transistor T1 is electrically connected to the first node N1.

In some other embodiments, as shown in FIGS. 9B, 12 and 13, the dimming sub-circuit 120 includes a first transistor T1, the first transistor T1 is connected between the first voltage terminal VDD and the third node N3, and a control electrode of the first transistor T1 is electrically connected to the first node N1.

In the above two embodiments, the pixel driving circuit 100 includes the driving transistor TD and the dimming sub-circuit 120 that are connected in series between the first voltage terminal VDD and the light-emitting device 200. The driving transistor TD and the dimming sub-circuit 120 work together to control the light-emitting device 200 to emit light. The relative positional relationship between the dimming sub-circuit 120 and the driving transistor TD does not affect the control of the on-state of the dimming sub-circuit 120 by the voltage at the first node N1 and can be adjusted according to actual conditions.

In some embodiments, as shown in FIGS. 9A to 21, the pixel driving circuit 100 further includes a capacitor Cst, a fourth transistor T4, a fifth transistor T5, a sixth transistor T6 and a seventh transistor T7. A first electrode plate of the capacitor Cst is electrically connected to the first voltage terminal VDD, and a second electrode plate of the capacitor Cst is electrically connected to the second node N2. A control electrode of the fourth transistor T4 is electrically connected to the scan signal terminal Gate, a first electrode of the fourth transistor T4 is electrically connected to a data signal terminal, and a second electrode of the fourth transistor T4 is electrically connected to the third node N3. A control electrode of the fifth transistor T5 is electrically connected to the scan signal terminal Gate, a first electrode of the fifth transistor T5 is electrically connected to the fourth node N4, and a second electrode of the fifth transistor T5 is electrically connected to the second node N2. A control electrode of the sixth transistor T6 is electrically connected to the reset signal terminal Reset, a first electrode of the sixth transistor T6 is electrically connected to an initialization signal terminal Vinit, and a second electrode of the sixth transistor T6 is electrically connected to the second node N2. A control electrode of the seventh transistor T7 is electrically connected to the scan signal terminal Gate, a first electrode of the seventh transistor T7 is electrically connected to the initialization signal terminal Vinit, and a second electrode of the seventh transistor T7 is electrically connected to the light-emitting device 200.

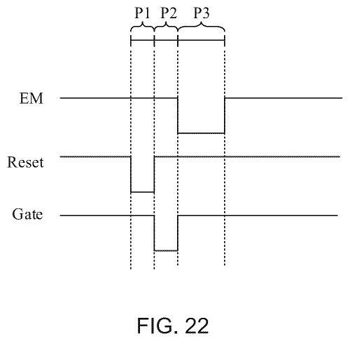

For example, the working process of the pixel driving circuit 100 will be exemplarily described below with reference to timings of signals output by the enable signal terminal EM, the scan signal terminal Gate, and the reset signal terminal Reset shown in FIG. 22. In the following description, the fourth transistor T4, the fifth transistor T5 and the seventh transistor T7 in the pixel driving circuit 100 are P-type transistors, the first voltage signal vdd transmitted by the first voltage terminal VDD is a high level signal, and the second voltage signal vss transmitted by the second voltage terminal VSS is a low level signal. It will be understood by those skilled in the art that in the pixel driving 20) circuit 100, a path between the first voltage terminal VDD and the second voltage terminal VSS is conductive, and the light-emitting device L emits light. The photosensitive device 110 only affects the on-state of the dimming sub-circuit 120, that is, the voltage of the first voltage signal vdd transmitted to the light-emitting device 200 by the dimming sub-circuit 120 changes with the change the intensity of light incident on the photosensitive device 110.

In a frame period, a driving process of the pixel driving circuit 100 may include a first phase P1, a second phase P2 and a third phase P3. For example, in the following description, “0” represents a low level, and “1” represents a high level. In the first phase P1, EM=1, Reset=0, Gate=1.

In this case, the fourth transistor T4, the fifth transistor T5 and the seventh transistor T7 are all turned off. The sixth transistor T6 is turned on to transmit an initialization signal vinit from the initialization signal terminal Vinit to the second node N2, so as to initialize the capacitor Cst and the control electrode of the driving transistor TD.

The dimming sub-circuit 120 is turned off, the path between the first voltage terminal VDD and the second voltage terminal VSS is disconnected, and the light-emitting device L does not emit light.

In the second phase P2, EM=1, Reset=1, Gate=0.

In this case, the fourth transistor T4 and the fifth transistor T5 are turned on, and the sixth transistor T6 is turned off. The data signal vdata from the data signal terminal Vdata is written into the capacitor Cst, and the threshold voltage of the driving transistor TD is written into the capacitor Cst. In this case, the voltage at the second node N2 is (vdata+Vth).

The seventh transistor T7 is turned on to transmit the initialization signal vinit from the initialization signal terminal Vinit to the pixel anode of the light-emitting device 200, so as to initialize the light-emitting device 200.

The dimming sub-circuit 120 is turned off, the path between the first voltage terminal VDD and the second voltage terminal VSS is disconnected, and the light-emitting device L does not emit light.

In the third phase P3, EM=0, Reset=1, Gate=1.

In this case, the fourth transistor T4, the fifth transistor T5, the sixth transistor T6 and the seventh transistor T7 are all turned off. The capacitor Cst discharges, the second node N2 maintains a low voltage (vdata+Vth), and the driving transistor TD is turned on.

The dimming sub-circuit 120 is turned on, the path between the first voltage terminal VDD and the second voltage terminal VSS is conductive, and the light-emitting device 200 emits light. The voltage at the third node N3 is vdd. In a case where the driving transistor TD is turned on, that is, in a case of (Vdata+Vth−Vdd) is greater than Vth ((Vdata+Vth−Vdd)>Vth), the voltage at the fourth node N4 is a high voltage.

It can be understood that in a case of the driving transistor DT being a P-type transistor, Vth is less than 0 (Vth<0); and in a case of the driving transistor TD is an N-type transistor, Vth is greater than 0 (Vth>0).

It can be seen from the above description of the pixel driving circuit 100 that, in the third phase P3 within a frame period, the pixel driving circuit 100 controls the light-emitting device 200 to emit light, and the enable signal terminal EM, the scan signal terminal Gate, the reset signal terminal Reset, the initialization signal terminal Vinit, the first voltage terminal VDD, the second voltage terminal VSS, the second node N2, the third node N3 and the fourth node N4 in the pixel driving circuit 100 all have potential signals for output. Based on this, the number and type of transistors in the dimming sub-circuit 120 are set, so that the pixel driving circuit 100 realizes the normal driving process of initialization of the capacitor Cst in the first phase P1, data writing into the capacitor Cst in the second phase P2, and the light-emitting device 200 emitting light in the third phase P3.

In the following embodiments, as shown in FIGS. 9A to 21, the specific structure of the dimming sub-circuit 120 will be described in detail according to different control signals Ctl received by the first terminal of the photosensitive device 110 (i.e., different signal terminals or nodes electrically connected to the first terminal of the photosensitive device 110).

The description will be made by taking the dimming sub-circuit 120 including two transistors as an example. As shown in FIGS. 9A to 13, the dimming sub-circuit 120 includes the first transistor T1 and a second transistor T2.

In some embodiments, the connection relationship between the first transistor T1 and the second transistor T2 is as shown in FIGS. 9A, 10 and 11. The control electrode of the first transistor T1 is electrically connected to the first node N1, the first electrode of the first transistor T1 is electrically connected to the fourth node N4, and the second electrode of the first transistor T1 is electrically connected to the light-emitting device 200. A control electrode of the second transistor T2 is electrically connected to the first node N1 or the enable signal terminal EM, a first electrode of the second transistor T2 is electrically connected to the first voltage terminal VDD, and a second electrode of the second transistor T2 is electrically connected to the third node N3.

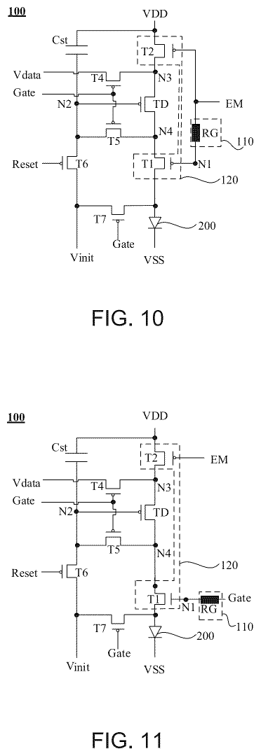

In some examples, as shown in FIGS. 9A and 10, the first terminal of the photosensitive device 110 is electrically connected to the enable signal terminal EM, and the control signal Ctl received by the first terminal of the photosensitive device 110 is the enable signal em.

For example, as shown in FIG. 9A, in this case, the control electrodes of the first transistor T1 and the second transistor T2 in the dimming sub-circuit 120 are both electrically connected to the first node N1. The first electrode of the second transistor T2 is electrically connected to the first voltage terminal VDD, and the second electrode of the second transistor T2 is electrically connected to the third node N3. The first electrode of the first transistor T1 is electrically connected to the fourth node N4, and the second electrode of the first transistor T1 electrically connected to the light-emitting device 200.

In this way, the enable signal em output by the enable signal terminal EM flows to the first node N1 through the photosensitive device 110. Under the control of the voltage at the first node N1, the conduction degrees of the first transistor T1 and the second transistor T2 in the dimming sub-circuit 120 both change, so as to control the magnitude of the first voltage signal vdd from the first voltage terminal VDD transmitted to the light-emitting device 200, thereby adjusting the brightness of the light-emitting device 200.

For example, as shown in FIG. 10, in this case, the control electrode of the first transistor T1 in the dimming sub-circuit 120 is electrically connected to the first node N1, the first electrode of the first transistor T1 is electrically connected to the fourth node N4, and the second electrode of the first transistor T1 electrically connected to the light-emitting device 200. The control electrode of the second transistor T2 is electrically connected to the enable signal terminal EM, the first electrode of the second transistor T2 is electrically connected to the first voltage terminal VDD, and the second electrode of the second transistor T2 is electrically connected to the third node N3.

In this way, the enable signal em output by the enable signal terminal EM flows to the first node N1 through the photosensitive device 110. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage at the fourth node N4 transmitted to the light-emitting device 200, thereby adjusting the brightness of the light-emitting device 200.

In some other examples, as shown in FIG. 11, the first terminal of the photosensitive device 110 is electrically connected to the scan signal terminal Gate, the control signal Ctl received by the first terminal of the photosensitive device 110 is the scan signal gate, and the second terminal of the photosensitive device 110 is electrically connected to the first node N1.

The control electrode of the first transistor T1 in the dimming sub-circuit 120 is electrically connected to the first node N1, the first electrode of the first transistor T1 is electrically connected to the fourth node N4, and the second electrode of the first transistor T1 is electrically connected to the light-emitting device 200. The control electrode of the second transistor T2 is electrically connected to the enable signal terminal EM, the first electrode of the second transistor T2 is electrically connected to the first voltage terminal VDD, and the second electrode of the second transistor T2 is electrically connected to the third node N3.

In this way, the scan signal gate output by the scan signal terminal Gate flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage at the fourth node N4 transmitted to the light-emitting device 200, thereby adjusting the brightness of the light-emitting device 200.

In some other embodiments, the dimming sub-circuit 120 includes the first transistor T1 and the second transistor T2, and the connection relationship between the first transistor T1 and the second transistor T2 is as shown in FIGS. 9B, 12 and 13. The control electrode of the first transistor T1 is electrically connected to the first node N1, the first electrode of the first transistor T1 is electrically connected to the first voltage terminal VDD, and the second electrode of the first transistor T1 is electrically connected to the third node N3. The control electrode of the second transistor T2 is electrically connected to the first node N1 or the enable signal terminal EM, the first electrode of the second transistor T2 is electrically connected to the fourth node N4, and the second electrode of the second transistor T2 is electrically connected to the light-emitting device 200.

In some examples, with continued reference to FIGS. 9B, 12 and 13, the first terminal of the photosensitive device 110 is electrically connected to the enable signal terminal EM or the scan signal terminal Gate.

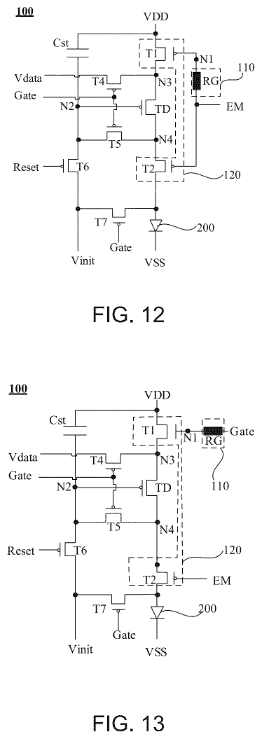

For example, as shown in FIG. 12, the first terminal of the photosensitive device 110 is electrically connected to the enable signal terminal EM, the control signal Ctl received by the first terminal of the photosensitive device 110 is the enable signal em, and the second terminal of the photosensitive device 110 is electrically connected to the first node N1.

The control electrode of the first transistor T1 in the dimming sub-circuit 120 is electrically connected to the first node N1, the first electrode of the first transistor T1 is electrically connected to the first voltage terminal VDD, and the second electrode of the first transistor T1 is electrically connected to the third node N3. The control electrode of the second transistor T2 is electrically connected to the enable signal terminal EM, the first electrode of the second transistor T2 is electrically connected to the fourth node N4, and the second electrode of the second transistor T2 is electrically connected to the light-emitting device 200.

In this way, the enable signal em output by the enable signal terminal EM flows to the first node N1 through the photosensitive device 110. Under the control of the voltage at the first node N1, the conduction degree of the first transistor T1 in the dimming sub-circuit 120 changes, so as to control the magnitude of the first voltage signal vdd from the first voltage terminal VDD transmitted to the third node N3, thereby adjusting the brightness of the light-emitting device 200.

For example, as shown in FIG. 13, the first terminal of the photoresistor RG is electrically connected to the scan signal terminal Gate, the control signal Ctl received by the first terminal of the photoresistor RG is the scan signal gate, and the second terminal of the photoresistor RG is electrically connected to the first node N1.

The control electrode of the first transistor T1 in the dimming sub-circuit 120 is electrically connected to the first node N1, the first electrode of the first transistor T1 is electrically connected to the first voltage terminal VDD, and the second electrode of the first transistor T1 is electrically connected to the third node N3. The control electrode of the second transistor T2 is electrically connected to the enable signal terminal EM, the first electrode of the second transistor T2 is electrically connected to the fourth node N4, and the second electrode of the second transistor T2 is electrically connected to the light-emitting device 200.

In this way, the scan signal gate output by the scan signal terminal Gate flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the third node N3, thereby adjusting the brightness of the light-emitting device 200 by adjusting the magnitude of the voltage at the third node N3.

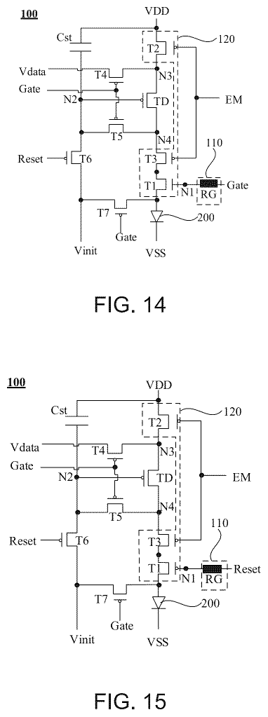

The description will be made by taking the dimming sub-circuit 120 including three transistors as an example. As shown in FIGS. 14 to 21, the dimming sub-circuit 120 includes the first transistor T1, a second transistor T2 and a third transistor T3.

In some embodiments, the connection relationship between the first transistor T1, the second transistor T2 and the third transistor T3 is as shown in FIGS. 14 to 21. A control electrode of the second transistor T2 is electrically connected to the enable signal terminal EM, a first electrode of the second transistor T2 is electrically connected to the first voltage terminal VDD, and a second electrode of the second transistor T2 is electrically connected to the third node N3. The third transistor T3 and the first transistor T1 are connected in series between the fourth node N4 and the light-emitting device 200, and the control electrode of the third transistor T3 is electrically connected to the enable signal terminal EM.

For example, as shown in FIGS. 14 to 21, the control electrode of the third transistor T3 is electrically connected to the enable signal terminal EM, a first electrode of the third transistor T3 is electrically connected to the fourth node N4, and a second electrode of the third transistor T3 is electrically connected to the first electrode of the first transistor T1. The control electrode of the first transistor T1 is electrically connected to the first node N1, and the second electrode of the first transistor T1 is electrically connected to the light-emitting device 200. The light-emitting device 200 is electrically connected to the second voltage terminal VSS.

The normal driving process of the pixel driving circuit 100 is implemented by considering the connection relationship between the second transistor T2 and the third transistor T3. In this way, the first terminal of the photoresistor RG electrically connected to the control electrode of the first transistor T1 may be electrically connected to any of the enable signal terminal EM, the scan signal terminal Gate, the reset signal terminal Reset, the initialization signal terminal Vinit, the first voltage terminal VDD, the second voltage terminal VSS, the second node N2, the third node N3 or the fourth node N4.

In some examples, as shown in FIG. 14, the first terminal of the photoresistor RG is electrically connected to the scan signal terminal Gate, and the control signal Ctl received by the first terminal of the photoresistor RG is the scan signal gate. As shown in FIG. 22, the scan signal gate output by the scan signal terminal Gate outputs a high-level signal in the third phase P3.

In this way, the scan signal gate output by the scan signal terminal Gate flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage of the second electrode of the third transistor T3 transmitted to the light-emitting device 200, thereby adjusting the brightness of the light-emitting device 200.

In some examples, as shown in FIG. 15, the first terminal of the photoresistor RG is electrically connected to the reset signal terminal Reset, and the control signal Ctl received by the first terminal of the photoresistor RG is the reset signal reset. As shown in FIG. 22, the reset signal reset output by the reset signal terminal Reset outputs a high-level signal in the third phase P3.

In this way, the reset signal reset output by the reset signal terminal Reset flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage of the second electrode of the third transistor T3 transmitted to the light-emitting device 200, thereby adjusting the brightness of the light-emitting device 200.

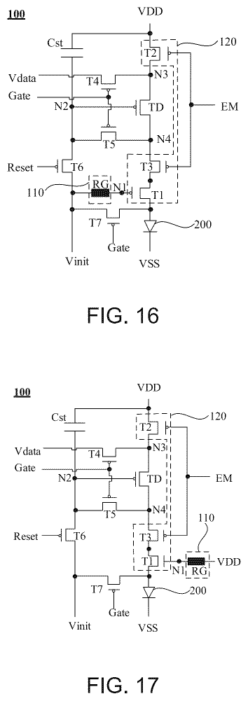

In some examples, as shown in FIG. 16, the first terminal of the photoresistor RG is electrically connected to the initialization signal terminal Vinit, and the control signal Ctl received by the first terminal of the photoresistor RG is an initial signal vinit. The initial signal vinit is a constant low-level signal.

In this way, the initial signal vinit output by the initialization signal terminal Vinit flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage of the second electrode of the third transistor T3 transmitted to the light-emitting device 200, thereby adjusting the brightness of the light-emitting device 200.

In some examples, as shown in FIG. 17, the first terminal of the photoresistor RG is electrically connected to the first voltage terminal VDD, and the control signal Ctl received by the first terminal of the photoresistor RG is the first voltage signal vdd. The first voltage signal vdd is a constant high-level signal.

In this way, the first voltage signal vdd output by the first voltage terminal VDD flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage of the second electrode of the third transistor T3 transmitted to the light-emitting device 200, thereby adjusting the brightness of the light-emitting device 200.

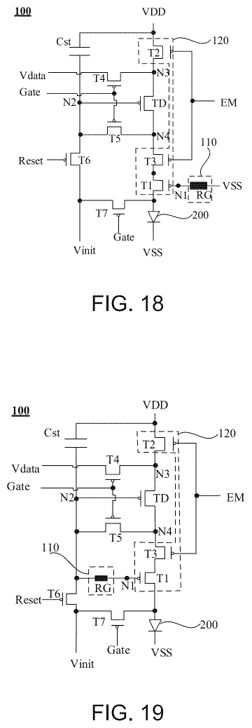

In some examples, as shown in FIG. 18, the first terminal of the photoresistor RG is electrically connected to the second voltage terminal VSS, and the control signal Ctl received by the first terminal of the photoresistor RG is the second voltage signal vss. The second voltage signal vss is a constant low-level signal.

In this way, the second voltage signal vss output by the second voltage terminal VSS flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage of the second electrode of the third transistor T3 transmitted to the light-emitting device 200, thereby adjusting the brightness of the light-emitting device 200.

In some examples, as shown in FIG. 19, the first terminal of the photoresistor RG is electrically connected to the second node N2, and the control signal Ctl received by the first terminal of the photoresistor RG is the voltage at the second node N2, that is, (vdata+Vth). The voltage at the second node N2 is a low-level signal.

In this way, the voltage at the second node N2 flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage of the second electrode of the third transistor T3 transmitted to the light-emitting device 200, thereby adjusting the brightness of the light-emitting device 200.

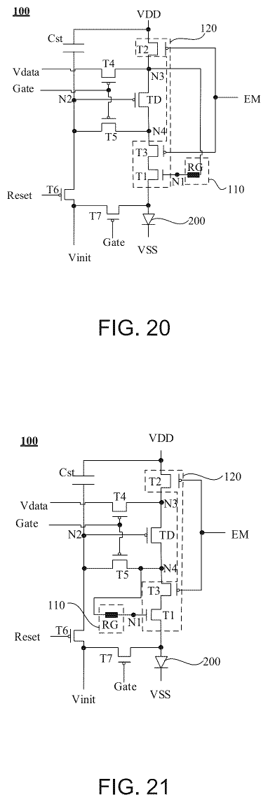

In some examples, as shown in FIG. 20, the first terminal of the photoresistor RG is electrically connected to the third node N3, and the control signal Ctl received by the first terminal of the photoresistor RG is the voltage at the third node N3, that is, the first voltage signal vdd from the first voltage terminal VDD transmitted to the third node N3 in the third period P3. The voltage at the third node N3 is a high-level signal.

In this way, the voltage at the third node N3 flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage 20) of the second electrode of the third transistor T3 transmitted to the light-emitting device 200, thereby adjusting the brightness of the light-emitting device 200.

In some examples, as shown in FIG. 21, the first terminal of the photoresistor RG is electrically connected to the fourth node N4, and the control signal Ctl received by the first terminal of the photoresistor RG is the voltage at the fourth node N4, that is, the voltage at the fourth node N4 is a high-level signal in the third period P3.

In this way, the voltage at the fourth node N4 flows to the first node N1 through the photoresistor RG. Under the control of the voltage at the first node N1, the conduction degree of the first transistor T1 in the dimming sub-circuit 120 changes, so as to control the magnitude of the first voltage signal vdd from the first voltage terminal VDD transmitted to the light-emitting device 200, that is, control the magnitude of the voltage of the second electrode of the third transistor T3 transmitted to the light-emitting device 200, thereby adjusting the brightness of the light-emitting device 200.

It can be seen from setting the type of the first transistor T1 according to the different signal terminals or nodes connected to the first terminal of the photoresistor RG in the above embodiments that, in some examples, as shown in FIGS. 11, 13, 14, 17, 20 and 21, in a case where the first terminal of the photoresistor RG is electrically connected to any of the first voltage terminal VDD, the scan signal terminal Gate, the third node N3 and the fourth node N4, the polarity of the first transistor T1 is opposite to the polarities of the driving transistor TD, the second transistor T2, the fourth transistor T4, the fifth transistor T5, the sixth transistor T6 and the seventh transistor T7. In a case where the dimming sub-circuit 120 further includes the third transistor T3, the polarity of the first transistor T1 is also opposite to the polarity of the third transistor T3.

For example, as shown in FIGS. 11 and 13, in a case where the dimming sub-circuit 120 includes the first transistor T1 and the second transistor T2, the driving transistor TD, the second transistor T2, the fourth transistor T4, the fifth transistor T5, the sixth transistor T6 and the seventh transistor T7 are all P-type transistors, and the first transistor T1 is an N-type transistor. As shown in FIGS. 14, 17, 20 and 21, in a case where the dimming sub-circuit 120 further includes the third transistor T3, the driving transistor TD, the second transistor T2, the third transistor T3, the fourth transistor T4, the fifth transistor T5, the sixth transistor T6 and the seventh transistor T7 are all P-type transistors, and the first transistor T1 is an N-type transistor.

In some other examples, as shown in FIGS. 9A, 9B, 10, 12, 15, 16, 18 and 19, in a case where the first terminal of the photosensitive device 110 is electrically connected to any of the enable signal terminal EM, the reset signal terminal Reset, the initialization signal terminal Vinit, the second voltage terminal VSS and the second node N2, the polarity of the first transistor T1 is the same as the polarities of the driving transistor TD, the second transistor T2, the fourth transistor T4, the fifth transistor T5, the sixth transistor T6 and the seventh transistor T7. In a case where the dimming sub-circuit 120 further includes the third transistor T3, the polarity of the first transistor T1 is also the same as the polarity of the third transistor T3.

For example, as shown in FIGS. 9A, 9B, 10 and 12, in a case where the dimming sub-circuit 120 includes the first transistor T1 and the second transistor T2, the driving transistor TD, the second transistor T2, the fourth transistor T4, the fifth transistor T5, the sixth transistor T6 and the seventh transistor T7 are all P-type transistors, and the first transistor T1 is a P-type transistor. As shown in FIGS. 15, 16, 18 and 19, in a case where the dimming sub-circuit 120 further includes the third transistor T3, the driving transistor TD, the second transistor T2, the third transistor T3, the fourth transistor T4, the fifth transistor T5, the sixth transistor T6 and the seventh transistor T7 are all P-type transistors, and the first transistor T1 is a P-type transistor.

In the description of the specification, specific features, structures, materials, or features may be combined in any one or more embodiments or examples in a suitable manner.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. A pixel driving circuit, comprising:
a photosensitive device, a first terminal of the photosensitive device being configured to receive a control signal, and a second terminal of the photosensitive device being electrically connected to a first node, wherein a resistance of the photosensitive device changes as an intensity of light incident on the photosensitive device changes, the photosensitive device is configured to adjust a voltage at the first node based on the control signal; and
a dimming sub-circuit connected between a first voltage terminal and a light-emitting device and electrically connected to the first node, wherein an on-state of the dimming sub-circuit changes as the voltage at the first node changes, and the dimming sub-circuit is configured to adjust brightness of the light-emitting device based on a first voltage signal from the first voltage terminal under control of the voltage at the first node.

2. The pixel driving circuit according to claim 1, further comprising:
a driving transistor, a control electrode of the driving transistor being electrically connected to a second node, a first electrode of the driving transistor being electrically connected to a third node, and a second electrode of the driving transistor being electrically connected to a fourth node; wherein
the dimming sub-circuit includes a first transistor connected between the fourth node and the light-emitting device, and a control electrode of the first transistor is electrically connected to the first node.

3. The pixel driving circuit according to claim 2, wherein the first terminal of the photosensitive device is electrically connected to an enable signal terminal; and
the dimming sub-circuit further includes a second transistor, a control electrode of the second transistor is electrically connected to the first node or the enable signal terminal, a first electrode of the second transistor is electrically connected to the first voltage terminal, and a second electrode of the second transistor is electrically connected to the third node.

4. The pixel driving circuit according to claim 2, wherein the first terminal of the photosensitive device is electrically connected to a scan signal terminal; and
the dimming sub-circuit further includes a second transistor, a control electrode of the second transistor is electrically connected to the enable signal terminal, a first electrode of the second transistor is electrically connected to the first voltage terminal, and a second electrode of the second transistor is electrically connected to the third node.

5. The pixel driving circuit according to claim 2, wherein the first terminal of the photosensitive device is electrically connected to any one of an enable signal terminal, a scan signal terminal, a reset signal terminal, an initialization signal terminal, the first voltage terminal, a second voltage terminal, the second node, the third node or the fourth node; the light-emitting device is electrically connected to the second voltage terminal; and
the dimming sub-circuit further includes a second transistor and a third transistor, wherein
a control electrode of the second transistor is electrically connected to the enable signal terminal, a first electrode of the second transistor is electrically connected to the first voltage terminal, and a second electrode of the second transistor is electrically connected to the third node; and
a control electrode of the third transistor is electrically connected to the enable signal terminal, the third transistor is connected between the fourth node and the light-emitting device, and the third transistor and the first transistor are connected in series.

6. The pixel driving circuit according to claim 1, further comprising:
a driving transistor, a control electrode of the driving transistor being electrically connected to a second node, a first electrode of the driving transistor being electrically connected to a third node, and a second electrode of the driving transistor being electrically connected to a fourth node; wherein
the dimming sub-circuit includes a first transistor, a control electrode of the first transistor is electrically connected to the first node, a first electrode of the first transistor is electrically connected to the first voltage terminal, and a second electrode of the first transistor is electrically connected to the third node.

7. The pixel driving circuit according to claim 6, wherein the first terminal of the photosensitive device is electrically connected to an enable signal terminal or a scan signal terminal;
the dimming sub-circuit further includes a second transistor, a control electrode of the second transistor is electrically connected to the enable signal terminal, a first electrode of the second transistor is electrically connected to the fourth node, and a second electrode of the second transistor is electrically connected to the light-emitting device.

8. The pixel driving circuit according to claim 2, further comprising:
a capacitor, a first electrode plate of the capacitor being electrically connected to the first voltage terminal, and a second electrode plate of the capacitor being electrically connected to the second node;
a fourth transistor, a control electrode of the fourth transistor being electrically connected to a scan signal terminal, a first electrode of the fourth transistor being electrically connected to a data signal terminal, and a second electrode of the fourth transistor being electrically connected to the third node;
a fifth transistor, a control electrode of the fifth transistor being electrically connected to the scan signal terminal, a first electrode of the fifth transistor being electrically connected to the fourth node, and a second electrode of the fifth transistor being electrically connected to the second node;
a sixth transistor, a control electrode of the sixth transistor being electrically connected to a reset signal terminal, a first electrode of the sixth transistor being electrically connected to an initialization signal terminal, and a second electrode of the sixth transistor being electrically connected to the second node; and
a seventh transistor, a control electrode of the seventh transistor being electrically connected to the scan signal terminal, a first electrode of the seventh transistor being electrically connected to the initialization signal terminal, and a second electrode of the seventh transistor being electrically connected to the light-emitting device.

9. The pixel driving circuit according to claim 8, wherein the dimming sub-circuit further includes a second transistor, a control electrode of the second transistor is electrically connected to the first node or an enable signal terminal, a first electrode of the second transistor is electrically connected to the first voltage terminal, and a second electrode of the second transistor is electrically connected to the third node; or
the dimming sub-circuit further includes a second transistor and a third transistor; a control electrode of the second transistor is electrically connected to the enable signal terminal, a first electrode of the second transistor is electrically connected to the first voltage terminal, and a second electrode of the second transistor is electrically connected to the third node; a control electrode of the third transistor is electronically connected to the enable signal terminal, the third transistor is connected between the fourth node and the light-emitting device, and the third transistor and the first transistor are connected in series; wherein
in a case where the first terminal of the photosensitive device is electrically connected to any one of the first voltage terminal, the scan signal terminal, the third node and the fourth node, a polarity of the first transistor is opposite to polarities of the driving transistor, the second transistor, and the fourth to seventh transistors; in a case where the dimming sub-circuit further includes a third transistor, the polarity of the first transistor is also opposite to a polarity of the third transistor;
in a case where the first terminal of the photosensitive device is electrically connected to any one of the enable signal terminal, the reset signal terminal, the initialization signal terminal, a second voltage terminal and the second node, the polarity of the first transistor is same as the polarities of the driving transistor, the second transistor, and the fourth to seventh transistors; in the case where the dimming sub-circuit further includes the third transistor, the polarity of the first transistor is also same as the polarity of the third transistor.

10. A display module, comprising:
a substrate;
a plurality of pixel driving circuits each according to claim 1, and the plurality of pixel driving circuits being disposed on the substrate; and
a plurality of light-emitting devices disposed on a side of the plurality of pixel driving circuits away from the substrate, and the light-emitting devices being electrically connected to the pixel driving circuits.

11. The display module according to claim 10, wherein the display module has a light-transmitting area, the light-transmitting area is provided with at least one photosensitive device therein, and each photosensitive device is electrically connected to multiple pixel driving circuits in the plurality of pixel driving circuits.

12. The display module according to claim 10, wherein the display module comprises:
a photosensitive layer disposed on the side of the plurality of pixel driving circuits away from the substrate, wherein the photosensitive layer includes a plurality of photosensitive devices, and each photosensitive device is electrically connected to one or more pixel driving circuits in the plurality of pixel driving circuits.

13. The display module according to claim 10, further comprising:
a chip on film electrically connected to the plurality of pixel driving circuits; and
a flexible printed circuit electrically connected to the chip on film, wherein a surface of the flexible printed circuit is provided with at least one photosensitive device thereon, and in a case of the flexible printed circuit being bent to a back side of the substrate, the photosensitive device is closer to the substrate than the flexible printed circuit; wherein
each photosensitive device is electrically connected to multiple pixel driving circuits in the plurality of pixel driving circuits.

14. A display apparatus, comprising the display module according to claim 1 and a housing.

15. An intelligent watch, comprising the display module according to claim 1 and a supporting component.

16. The pixel driving circuit according to claim 6, further comprising:
a capacitor, a first electrode plate of the capacitor being electrically connected to the first voltage terminal, and a second electrode plate of the capacitor being electrically connected to the second node;
a fourth transistor, a control electrode of the fourth transistor being electrically connected to a scan signal terminal, a first electrode of the fourth transistor being electrically connected to a data signal terminal, and a second electrode of the fourth transistor being electrically connected to the third node;
a fifth transistor, a control electrode of the fifth transistor being electrically connected to the scan signal terminal, a first electrode of the fifth transistor being electrically connected to the fourth node, and a second electrode of the fifth transistor being electrically connected to the second node;
a sixth transistor, a control electrode of the sixth transistor being electrically connected to a reset signal terminal, a first electrode of the sixth transistor being electrically connected to an initialization signal terminal, and a second electrode of the sixth transistor being electrically connected to the second node; and
a seventh transistor, a control electrode of the seventh transistor being electrically connected to the scan signal terminal, a first electrode of the seventh transistor being electrically connected to the initialization signal terminal, and a second electrode of the seventh transistor being electrically connected to the light-emitting device.

17. The pixel driving circuit according to claim 16, wherein the dimming sub-circuit further includes a second transistor, a control electrode of the second transistor is electrically connected to an enable signal terminal, a first electrode of the second transistor is electrically connected to the fourth node, and a second electrode of the second transistor is electrically connected to the light-emitting device; wherein
in a case where the first terminal of the photosensitive device is electrically connected to any one of the first voltage terminal, the scan signal terminal, the third node and the fourth node, a polarity of the first transistor is opposite to polarities of the driving transistor, the second transistor, and the fourth to seventh transistors;
in a case where the first terminal of the photosensitive device is electrically connected to any one of the enable signal terminal, the reset signal terminal, the initialization signal terminal, a second voltage terminal and the second node, the polarity of the first transistor is same as the polarities of the driving transistor, the second transistor, and the fourth to seventh transistors.
